(19) United States
(12) Patent Application Publication
(10) Pub. No.: US 2020/0121117 A1
(43) Pub. Date: Apr. 23, 2020

(54) APPARATUS AND METHOD FOR BREWING COFFEE

(71) Applicant: Eric Wettlaufer, Buffalo, NY (US)

(72) Inventor: Eric Wettlaufer, Buffalo, NY (US)

(21) Appl. No.: 16/655,726

(22) Filed: Oct. 17, 2019

Related U.S. Application Data
(60) Provisional application No. 62/746,772, filed on Oct. 17, 2018.

(51) Int. Cl. A47J 31/20; A23F 5/26

(52) U.S. Cl. CPC A47J 31/20; A23F 5/26

(57) ABSTRACT

Apparatus and methods for brewing coffee includes a carafe vessel having an upper edge which is angled complimentary to a lower edge of a removable carafe top such that the carafe top lower edge may be placed in full circumferential mating engagement with the vessel upper edge. A collar having a spout encircles the upper edge of the carafe vessel and lower edge of the carafe top when in full mating engagement. A filter is positioned above the bottom of the vessel with air below the filter pushed up through the coffee grounds and hot water as the filter is pushed down to the bottom of the carafe. Once brewed the filter and grounds are withdrawn from the brewed coffee. The carafe top may be rotated on the vessel whereby the spout is covered by the carafe top when in full engagement and the spout is uncovered when the carafe top is moved to the partial engagement position. Brewed coffee within the vessel interior is dispensable through the spout when the carafe top is moved to the uncovered spout position and is prevented from dispensing through the spout when the carafe top is moved to the position covering the spout.

### BACKGROUND OF THE INVENTION

The present invention relates to apparatus and methods for brewing coffee, and more particularly relates to novel coffee pressing apparatus and methods.

A traditional “French press” coffee is a type of brewed coffee which is made using a carafe and a filter attached to a plunger. Ground coffee and hot water is deposited into the empty carafe whereupon the grounds become suspended in the hot water. The coffee grounds and water may be stirred and the coffee flavor is extracted from the coffee grounds into the hot water. The filter is then deposited into the carafe and is of a size that makes a snug yet sliding fit with the interior side wall of the carafe. The plunger is pushed downwardly causing the filter to move downwardly inside the carafe. As the filter is pushed down toward the bottom of the carafe, the brewed coffee solution is forced upwardly through the filter while pushing the coffee grounds to the bottom of the carafe. The brewed coffee is then poured from the carafe while the filter and grounds are still in the carafe.

There are several drawbacks of the traditional French press described above. One such drawback is that coffee grounds typically make their way into the brewed coffee after pressing. This may be due to several reasons including, for example, an imperfect seal between the filter and carafe. Should the seal allow grounds to pass between the filter and carafe side wall, the grounds will enter into the brewed coffee which is poured for drinking. Another drawback is that the grounds at the bottom of the carafe after pressing may continue to be extracted into the water which of course may freely pass back and forth through the filter. This may lead to coffee that is unintentionally strong or bitter. Yet another drawback is that the filter and spent grounds remain at the bottom of the carafe until the brewed coffee is completely dispensed from the carafe.

Once the brewed coffee is fully dispensed, the filter must be removed which draws the spent grounds up along the inside of the carafe. The carafe must therefore be thoroughly rinsed and washed until all grounds are gone. This adds to the time between brewing cycles using the same carafe and also allows the grounds to freely disperse making it difficult to keep the work area clean. These are factors that are important in a home setting and even more so in a commercial coffee establishment where service time is of the essence.

There therefore remains a need for an improved apparatus and method for brewing coffee in a press style which addresses the drawbacks of a conventional French coffee press.

### SUMMARY OF THE INVENTION

The present invention addresses the above needs by providing in a first aspect a coffee press having a carafe vessel, a carafe top which is movable with respect to the carafe vessel, and a coffee filter attached to a first end of a rod which, upon inserting the filter into the carafe vessel, extends upwardly and exteriorly of the carafe vessel at a second rod end. The rod end opposite the filter may include a knob to facilitate manual movement of the rod and filter within the carafe vessel. A ring element may encircle the filter and is of a size and shape allowing the filter and ring to together slide up and down inside the carafe vessel via manipulation of the rod while providing a liquid tight seal between the inside side wall of the carafe vessel and the circumference of the ring element. The ring element may be formed integrally with the filter or may be separately constructed and attached to the filter. The ring element and filter may be of the same or differing materials.

The carafe top has opposite upper and lower edges defining a center opening which extends completely through the carafe top from the upper to lower edge thereof. A lid may be provided for removable placement over the center opening at the upper edge. The lid may include an aperture through which the plunger rod may extend. The lid may be attached to the carafe top upper edge via a hinge connection. The bottom edge of the carafe top may lie along a plane which is angled relative to the plane in which the upper edge lies.

The carafe vessel may include an upper edge defining an opening. The carafe vessel upper edge may lie along a plane which is angled complimentary to the angle of the bottom edge of the carafe top such that the bottom edge of the carafe top may be placed in mating engagement with the upper edge of the carafe vessel upon seating the carafe top upon the upper edge of the carafe vessel.

A collar may be mounted to the outwardly facing side wall of the carafe vessel in a location encircling the angled upper edge of the carafe vessel. The collar may include a spout which may be formed separately but is preferably integrally formed with the collar and is located above the angled upper edge of the carafe vessel and extends radially outwardly of the outer surface of the side wall of the carafe vessel.

Upon seating the angled bottom edge of the carafe top in mating relation onto the angled upper edge of the carafe vessel, the longer side wall of the carafe top lies in covering relation to the base or inlet of the collar spout. This prevents fluid located in the carafe vessel from reaching the spout inlet even when the carafe vessel is tilted to a pouring position.

When it is desired to pour brewed coffee from the carafe vessel, the carafe top is rotated relative to the carafe vessel (either manually or by a motorized means, for example) whereupon the opposite, shorter side wall of the carafe top locates above the spout inlet which allows brewed coffee to be dispensed from the carafe vessel through the spout. In this “pour position” of the carafe top, the collar may encircle at least part of the carafe top which allows the carafe top to remain coupled to the vessel while pouring. As explained in detail below, when the carafe vessel is in the “pour position”, the spent grounds and filter are located adjacent the carafe top upper edge. The lid may cover the carafe top upper edge such that the spent grounds and filter do not fall from the carafe top while pouring brewed coffee.

In another aspect, the present invention provides a method for brewing coffee including the steps of:

a) providing a carafe vessel having a bottom wall, side wall and an angled upper edge defining an open top;

b) providing a carafe top having an upper edge and a bottom edge with the bottom edge lying along a plane which is angled complimentary to the plane along which the carafe vessel upper edge lies, and seating the carafe top onto the carafe vessel with the angled upper edge of the carafe vessel in full mating contact with the angled bottom edge of the carafe top;

c) providing a collar on the outwardly facing side wall of the carafe vessel in a location encircling the angled upper edge of the carafe vessel, the collar having a spout which is located above the angled upper edge and radially outwardly of the outer surface of the side wall of the carafe vessel, the carafe top side wall covering the inlet of the collar spout when the carafe top angled lower edge is positioned in full mating engagement with the angled upper edge of the carafe vessel;

d) providing a coffee filter attached to a rod and placing the coffee filter into the carafe vessel at a location spaced above the vessel bottom wall, the filter having a circumferential sealing edge providing a sliding yet liquid tight seal with the inner surface of the carafe vessel side wall;

e) depositing ground coffee into the carafe vessel and onto the upwardly facing surface of the coffee filter;

d) dispensing hot water into the carafe vessel;

e) moving the rod and filter toward the carafe vessel bottom wall whereby air located in the space between the carafe vessel bottom wall and filter is forced upwardly through the filter in a direction toward the carafe vessel upper edge;

f) pulling the rod and filter upwardly in a direction away from the carafe vessel bottom wall whereupon the water in the vessel is forced downwardly through the filter in a direction toward the vessel carafe bottom wall;

g) locating the filter adjacent the upper edge of the carafe top;

h) rotating the carafe top relative to the carafe vessel until the spout is no longer covered by the carafe top side wall;

i) tilting the carafe vessel whereupon brewed coffee is dispensed from the carafe vessel though the spout.

The method may include the step of providing a lid on the carafe top upper edge.

The method may include the step of removing the carafe top from the carafe vessel together with the filter and lid with the grounds located between the filter and lid.

The method may include the step of removing the lid and grounds from the filter.

It will be appreciated that since the extracted coffee grounds are pulled up and out of the hot water as soon as brewing is complete, the brewed coffee can be intermittingly poured from the carafe vessel without the brewed coffee continuing to extract from the grounds which thereby maintains the brewed coffee concentration and thus provides a more consistent taste between intermittent pours of the brewed coffee from the carafe vessel.

Additional objects, advantages and novel aspects of the present invention will be set forth in part in the description which follows, and will in part become apparent to those in the practice of the invention, when considered with the attached figures.

### DESCRIPTION OF THE DRAWING FIGURES

The above-mentioned and other features and advantages of this invention, and the manner of attaining them, will become apparent and be better understood by reference to the following description of the invention in conjunction with the accompanying drawing, wherein:

FIG. 1A is a side elevational view of an embodiment of the invention in a first position of operation;

FIG. 1B is the view of FIG. 1A showing the carafe top removed and spaced above the carafe vessel;

FIG. 2 is a side elevational view of an embodiment of the invention in a second state of operation;

FIG. 3 is a side elevational view of an embodiment of the invention in a third state of operation;

FIG. 4 is a side elevational view of an embodiment of the invention in a fourth state of operation;

FIG. 5 is a side elevational view of an embodiment of the invention in a fifth state of operation;

FIG. 6 is a side elevational view of an embodiment of the invention in a sixth state of operation;

FIG. 7 is a side elevational view of an embodiment of the invention showing both a standing, ready-to-pour position and in a tilted pouring position;

FIG. 8 is a side elevational view of an embodiment of the invention showing the carafe top with coffee grounds and filter spaced above the carafe vessel thereof;

FIG. 9 is a top plan view of the carafe collar;

FIG. 10 is a side elevational view of an embodiment of the invention showing the carafe top with coffee grounds and filter spaced above the carafe top;

FIG. 11 is a fragmented, perspective view of the upper half of an embodiment of the invention;

FIG. 12 is an elevational view partly in section of a of the invention; and

FIG. 13 is a perspective view of a filter of an embodiment of the invention.

### DETAILED DESCRIPTION OF A PREFERRED EMBODIMENT

Referring now to the Figures, the present invention provides in a first aspect a coffee press apparatus 10 which includes a carafe vessel 12 for holding a liquid and a carafe top 14 which is movable with respect to carafe vessel 12. In a preferred embodiment, vessel 12 and top 14 are cylindrical or oval in shape as seen in FIG. 11 although other configurations are possible and within the scope of the invention. A coffee filter 16 is attached to a ring element 18 and a rod 20. The ring element 18 may be integrally formed with filter 16 or be made as a separate part (see also FIGS. 12 and 13). Ring element 18 may include a circumferential sealing edge 18a for purposes described below. Ring element 18 and filter 16 may be of the same or dissimilar materials. By way of example and not limitation, filter 16 may be made of metal and ring element 18 may be made of silicone rubber.

Rod 20 has a first end 20a which attaches to and extends generally perpendicular to the plane of filter 16. In this regard, filter 16 may be substantially planar to allow an even bed depth of coffee grounds “G”. Rod 20 includes a second end 20b which may include a knob 20c or other handle configuration to facilitate manual manipulation of rod 20 and filter 16. When filter 16 and rod 20 are fully inserted into carafe vessel 12 (see FIG. 4), second end 20b and knob 20c are located exteriorly of vessel 12 and top 14.

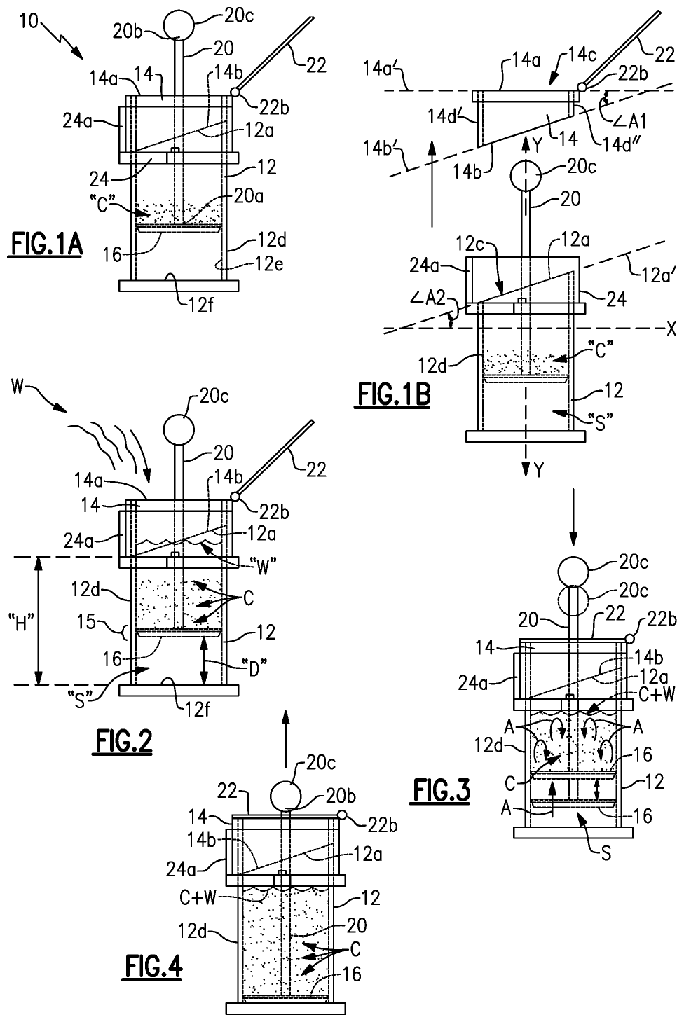

The carafe top 14 has an upper edge 14a lying along a first plane 14a′ and opposite lower edge 14b lying along a second plane 14b′ and defining a central opening 14c extending therebetween along a longitudinal axis Y-Y. A lid 22 may be provided for removable placement over the carafe top central opening 14c. The lid 22 may include a radially extending, elongated aperture 22a (see FIG. 11) through which the rod 20 may extend such that the lid 22 may be alternately opened and closed on carafe top 14 without removing rod 20 from vessel 12. The lid 22 may be separate from or attached to the carafe top upper edge 14a via a hinge connection 22b. The second plane 14b′ of lower edge 14b may lie at an acute angle “A1” with respect to the first plane 14a′ in which the upper edge 14a lies (see FIG. 1B).

The carafe vessel 12 may include an upper edge 12a defining an opening 12c which leads to the interior of the vessel 12 having interior wall surface 12e. The carafe vessel upper edge 12a may lie along a third plane 12a′ which extends at an acute angle “A2” relative to a fourth plane “X” which extends substantially perpendicular to the longitudinal axis Y-Y of vessel 12. Angles “A1” and “A2” are substantially the same such that carafe top lower edge 14b may be placed in full circumferential mating engagement with the upper edge 12a of the carafe vessel 12 upon seating the carafe top 14 upon the carafe vessel 12 as seen in FIGS. 1A and 2-6.

Referring to FIG. 5, vessel 12 has a long side wall section 12d′ and a short side wall section 12d″ having major and minor lengths L1 and L2, respectively. Likewise, carafe top 14 has long wall section 14d′ and a short side wall section 14d″ having major and minor lengths L3 and L4, respectively. The individual sums of (L1+L4) and (L2+L3) each equal the total length LT of carafe 12 and top 14 when in the fully mated, attached condition seen in FIGS. 1A and 2-6. Thus:

(L1+L4)=(L2+L3)=LT

(L1+L3)>LT

(L2+L4)<LT

A collar 24 may be mounted to the exterior side wall surface 12d of the carafe vessel 12 in a location encircling the angled upper edge 12c of the carafe vessel 12. The collar 24 may include a spout 24a which is located above the angled upper edge 12a of the carafe vessel 12 and radially outwardly (with respect to vessel longitudinal axis Y-Y) of the exterior wall surface 12d of the carafe vessel 12 (see also FIG. 9).

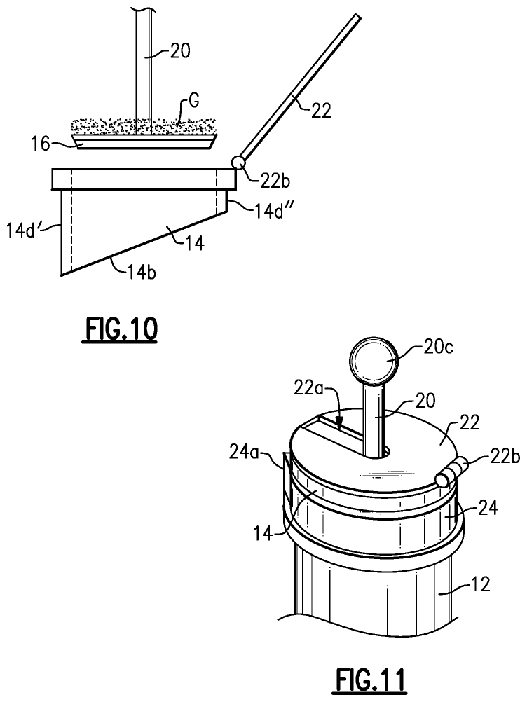

Upon seating the angled bottom edge 14b of the carafe top in mating relation onto the angled upper edge 12c of the carafe vessel 12, the longer side wall 14d′ of the carafe top 14 lies in covering relation to the inlet 24a′ of collar spout 24a. This prevents fluid exiting the carafe vessel 12 through the spout 24a, even when the carafe vessel 12 is tilted to a pouring position. When it is desired to pour brewed coffee from the carafe vessel 12, the carafe top 14 is rotated relative to the carafe vessel 12 about the longitudinal axis of rod 20 (see FIG. 6) until the opposite, shorter side wall 14d″ of the carafe top 14 locates in spaced relation above the spout 24a which allows the brewed beverage “B” to be dispensed from the carafe vessel 12 through the spout 24a (see FIG. 7).

Referring again to FIG. 2, a visual indicator 15 may be provided on vessel side wall 12d to indicate the location where the user is to initially locate the filter 18 in vessel 12. In an embodiment, the distance “D” between the vessel bottom wall 12f and the location of filter 18 is preferably no more than about half the height “H” of vessel 12 as measured along the shortest length 12d′ of vessel side wall 12d.

A space “S” is formed wherein a pocket of air is located. Hot water poured into carafe 12 sits upon the coffee “C” in filter 18 and may continue to fill the vessel 12 until the desired volume of water “W” is reached in carafe 12 above filter 18. Although the water is contacting the coffee, there is no appreciable extraction of the coffee “C” into the water “W” due to a lack of agitation.

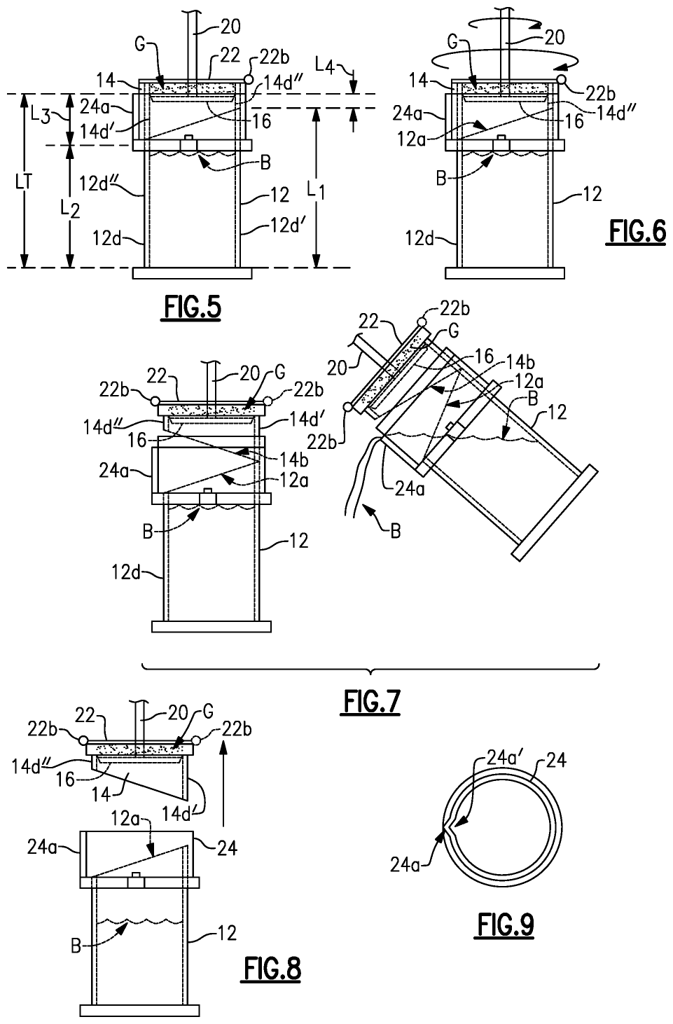

As seen in FIG. 3, once the desired amount of water is dispensed into vessel 12, the user pushes down on handle 20c and rod 20.

In an embodiment, the present invention provides apparatus for brewing coffee, comprising:

a) a carafe top having an upper edge and opposite lower edge with a central opening and extending between said upper and lower edges along a longitudinal axis, said upper edge lying along a first plane which extends perpendicular to said longitudinal axis of said central opening, said lower edge lying along a second plane which extends at an acute angle relative to said first plane;

b) a carafe vessel having exterior and interior wall surfaces and an upper edge defining an opening leading to the interior of said vessel, said vessel upper edge lying along a third plane which extends at an acute angle relative to a fourth plane which extends substantially perpendicular to the longitudinal axis of said vessel, said acute angle being substantially the same as said acute angle of said carafe top such that said carafe top lower edge may be removably placed in full circumferential mating engagement with said upper edge of said carafe vessel upon seating said carafe top lower edge upon said carafe vessel upper edge;

c) a filter having a circumferential edge which may be selectively moved within said vessel interior along said longitudinal axis in sliding, sealed engagement against said interior wall surface of said carafe vessel;

d) a rod attached to said filter and movable therewith, said rod having a second end extending exteriorly of said carafe vessel and said carafe top when said filter is located within said interior of said vessel and said carafe top is mounted on said carafe vessel; and

e) a lid removably attachable in covering relation to said upper edge of said carafe top, said lid including an aperture wherethrough said rod may slidingly extend.

The apparatus may include a collar mounted to the exterior wall surface 12d of the carafe vessel in a location encircling the angled upper edge of the carafe vessel. The collar may include a spout which is located above the angled upper edge of the carafe vessel and radially outwardly of the exterior wall surface of the carafe vessel.

In another embodiment, the present invention provides a method for brewing coffee including the steps of:

a) providing a carafe vessel 12 having a bottom wall 12f, side wall 12d and an angled upper edge 12a defining an open top 12c;

b) providing a carafe top 14 having an upper edge 14a and a bottom edge 14b with the bottom edge 14b lying along a plane which is angled complimentary to the plane along which the carafe vessel upper edge 12a lies, and seating the carafe top 14 onto the carafe vessel 12 with the angled upper edge 12a of the carafe vessel 12 in mating contact with the angled bottom edge 14b of the carafe top 14;

c) providing a collar 24 on the outwardly facing wall 12d of the carafe vessel 12 in a location encircling the angled upper edge 12a of the carafe vessel 12, the collar 24 having a spout 24a which is located above the angled upper edge 12a and radially outwardly of the outer surface of the side wall 12d of the carafe vessel 12, the carafe top long side wall 14d′ covering the collar spout 24a when the carafe top angled lower edge 14b is positioned in full mating engagement with the angled upper edge 12a of the carafe vessel 12;

d) providing a filter 18 attached to a rod 20 and placing the filter 18 into the carafe vessel 12 at a location spaced above the vessel bottom wall 12f (see FIG. 2), the filter 18 having a circumferential sealing edge 18′ providing a sliding yet liquid tight seal with the inside surface of the carafe vessel side wall 12;

e) depositing ground coffee “C” into the opening of the carafe vessel 12 and onto the upwardly facing surface 18a of the filter 18;

d) dispensing a quantity of hot water “W” into the carafe vessel;

e) moving the rod 20 and filter 18 toward the carafe vessel bottom wall 12f whereby air “A” located in the space “S” between the carafe vessel bottom wall 12f and filter 18 is forced upwardly through the filter 18 in a direction toward the carafe vessel upper edge 12a with the air “A’ circulating through the water and coffee mixture (C and W) and thereby facilitating the brewing process (see FIG. 3);

f) pulling the rod 20 and filter 18 upwardly in a direction away from the carafe vessel bottom wall 12f (see FIG. 4) whereupon the water “W” in the vessel 12 is forced downwardly through the filter 18 in a direction toward the vessel carafe bottom wall 12f (see FIG. 5);

g) locating the filter 18 adjacent the carafe top upper edge 14a (see FIG. 5);

h) rotating the carafe top 14 relative to the carafe vessel 12 until the spout 24a is no longer covered by the carafe top side wall 14d′ (see FIGS. 6 and 7);

i) tilting the carafe vessel 12 whereupon brewed coffee “B” is dispensed from the carafe vessel 12 though the spout 24a (see FIG. 7).

The method may include the step of providing a lid 22 on the carafe top upper edge 14a.

The method may include the step of providing a visual indicator 15 on vessel side wall 12d to indicate the location where the user is to initially locate the filter 18 (see FIG. 2). The distance “D” between the vessel bottom wall 12f and the location of filter 18 is preferably no more than about half the height “H” of vessel 12 as measured along the shortest part of the vessel side wall 12d.

The method may include the step of removing the carafe top 14 from the carafe vessel 12 together with the filter 18 and lid 22 with the grounds “G” located between the filter 18 and lid 22 (see FIG. 8).

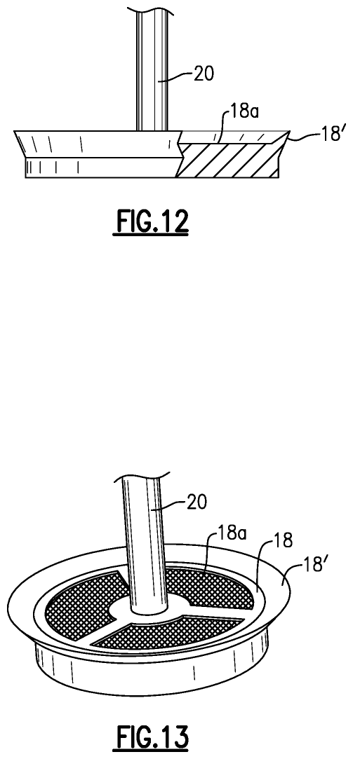

The method may include the step of opening the lid 22 and removing the grounds “G” and filter 18 from the carafe top 14 (see FIG. 10).

It will be appreciated that since the extracted coffee grounds “G” are pulled up and out of the vessel 12 as soon as brewing is complete, the brewed coffee “B” can be intermittingly poured from the carafe vessel 12 without the brewed coffee “B” continuing to extract from the grounds “G”. As such, the brewed coffee “B” tastes the same from the first to the last cup poured from a single brewing in vessel 12.

While the apparatus and methods have been shown and described with reference to certain preferred embodiments thereof, it will be understood by those skilled in the art that various changes in form and details may be made therein without departing from the spirit and scope of the invention as described.

What is claimed is:

1. Apparatus for brewing coffee, comprising:
a) a carafe top having an upper edge and opposite lower edge with a central opening and extending between said upper and lower edges along a longitudinal axis, said upper edge lying along a first plane which extends perpendicular to said longitudinal axis of said central opening, said lower edge lying along a second plane which extends at an acute angle relative to said first plane;
b) a carafe vessel having exterior and interior wall surfaces and an upper edge defining an opening leading to the interior of said vessel, said vessel upper edge lying along a third plane which extends at an acute angle relative to a fourth plane which extends substantially perpendicular to the longitudinal axis of said vessel, said acute angle being substantially the same as said acute angle of said carafe top such that said carafe top lower edge may be removably placed in full circumferential mating engagement with said upper edge of said carafe vessel upon seating said carafe top lower edge upon said carafe vessel upper edge;
c) a filter having a circumferential edge which may be selectively moved within said vessel interior along said longitudinal axis in sliding, sealed engagement against said interior wall surface of said carafe vessel;
d) a rod attached to said filter and movable therewith, said rod having a second end extending exteriorly of said carafe vessel and said carafe top when said filter is located within said interior of said vessel and said carafe top is mounted on said carafe vessel; and
e) a lid removably attachable in covering relation to said upper edge of said carafe top, said lid including an aperture wherethrough said rod may slidingly extend.

2. The apparatus of claim 1 and further comprising a collar mounted to said exterior wall surface of said carafe vessel in a location encircling said upper edge of said carafe vessel, said collar including a spout located above said angled upper edge of said carafe vessel and radially outwardly of said exterior wall surface of said carafe vessel.

3. The apparatus of claim 2 wherein said collar encircles said lower edge of said carafe top when said carafe top lower edge is in full circumferential mating engagement with said carafe vessel upper edge.

4. The apparatus of claim 3 wherein said carafe top is movable between said full circumferential engagement and a partial circumferential engagement, said spout being covered by said carafe top when in said full circumferential engagement and said spout being uncovered when said carafe top is moved to said partial circumferential engagement, fluid within said vessel interior being dispensable through said spout when uncovered, and fluid within said vessel interior being prevented from dispensing through said spout when said spout is covered by said carafe top.

5. The apparatus of claim 4 and further comprising an indicator marking on said vessel indicative of a pre-brew target location for said filter within said vessel.

6. A method for brewing coffee including the steps of:
a) providing a carafe vessel having a bottom wall, side wall and an angled upper edge defining an open top;
b) providing a carafe top having an upper edge and a bottom edge with the bottom edge lying along a plane which is angled complimentary to the plane along which the carafe vessel upper edge lies, and seating the carafe top 14 onto the carafe vessel with the angled upper edge of the carafe vessel in mating contact with the angled bottom edge of the carafe top;
c) providing a collar on the outwardly facing wall of the carafe vessel in a location encircling the angled upper edge of the carafe vessel, the collar having a spout which is located above the angled upper edge and radially outwardly of the outer surface of the side wall of the carafe vessel, the carafe top long side wall covering the collar spout when the carafe top angled lower edge is positioned in full mating engagement with the angled upper edge of the carafe vessel;
d) providing a filter attached to a rod and placing the filter into the carafe vessel at a location spaced above the vessel bottom wall, the filter having a circumferential sealing edge providing a sliding yet liquid tight seal with the inside surface of the carafe vessel side wall;
e) depositing ground coffee into the opening of the carafe vessel and onto the upwardly facing surface of the filter;
d) dispensing a quantity of hot water into the carafe vessel;
e) moving the rod and filter toward the carafe vessel bottom wall whereby air located in the space between the carafe vessel bottom wall and filter is forced upwardly through the filter in a direction toward the carafe vessel upper edge with the air circulating through the water and coffee mixture and thereby facilitating the brewing process;
f) pulling the rod and filter upwardly in a direction away from the carafe vessel bottom wall whereupon the water in the vessel is forced downwardly through the filter in a direction toward the vessel carafe bottom wall;
g) locating the filter adjacent the carafe top upper edge;
h) rotating the carafe top relative to the carafe vessel until the spout is no longer covered by the carafe top side wall;
i) tilting the carafe vessel whereupon brewed coffee is dispensed from the carafe vessel though the spout.

7. The method of claim 6 and further including the step of providing a lid on the carafe top upper edge.

8. The method of claim 7 and further including the step of providing a visual indicator on the vessel side wall to indicate the pre-brew location of the filter 18.

9. The method of claim 8 wherein the distance between the vessel bottom wall and the pre-brew location of the filter is preferably no more than about half the height of the vessel as measured along the shortest part of the vessel side wall.

10. The method of claim 7 and further including the step of removing the carafe top from the carafe vessel together with the filter and lid with the coffee grounds located between the filter and lid.

11. The method of claim 10 and further including the step of opening the lid and removing the grounds and filter from the carafe top 14.
